(19) United States
(12) Patent Application Publication
(10) Pub. No.: US 2019/0351893 A1
(43) Pub. Date: Nov. 21, 2019

(54) APPARATUS AND METHOD FOR CONTROLLING MILD HYBRID ELECTRIC VEHICLE

(71) Applicants: Hyundai Motor Company, Seoul (KR); Kia Motors Corporation, Seoul (KR)

(72) Inventor: YoungMin Kim, Yongin (KR)

(21) Appl. No.: 16/127,760

(22) Filed: Sep. 11, 2018

(30) Foreign Application Priority Data
May 18, 2018 (KR) 10-2018-0057189

(51) Int. Cl. B60W 20/15; B60K 6/26

(52) U.S. Cl. CPC B60W 20/15; B60K 6/26; B60K 2006/268; B60Y 2200/92; B60W 2550/20; B60W 2550/142; B60W 2710/244; B60W 2520/10

(57) ABSTRACT

An apparatus for controlling mild hybrid electric vehicle is provided. The apparatus includes an engine and a mild hybrid starter and generator (MHSG) that starts the engine or generates power by an output of the engine. A data receiving unit receives at least vehicle speed data, vehicle location data, and traffic information and a controller adjusts a state of charge criteria for idle stop restriction based on the data supplied from the data receiving unit.

### CROSS-REFERENCE TO RELATED APPLICATION

This application claims priority to and the benefit of Korean Patent Application No. 10-2018-0057189 filed on May 18, 2018, the entire contents of which are incorporated herein by reference.

### BACKGROUND

### (a) Field of the Invention

The present invention relates to an apparatus and method for controlling a mild hybrid electric vehicle, and more particularly, to an apparatus and method for controlling a mild hybrid electric vehicle that adjusts an idle stop entry condition based on driving conditions.

### (b) Description of the Related Art

As is generally known in the art, a hybrid electric vehicle utilizes an internal combustion engine and a battery power source together. The hybrid electric vehicle efficiently combines a torque of the internal combustion engine and torque of a motor. Hybrid electric vehicles may be divided into a full type and a mild type according to power sharing ratio between an engine and a motor. In the case of the mild type of hybrid electric vehicle (hereinafter referred to as a mild hybrid electric vehicle), a mild hybrid starter & generator (MHSG) configured to start the engine or generate electricity according to an output of the engine is used instead of an alternator. In the case of the full type of hybrid electric vehicle, a driving motor configured to generate driving torque is used in addition to an integrated starter & generator (ISG) configured to start the engine or generate electricity.

The MHSG may assist torque of the engine according to running states of the vehicle and may be configured to charge a battery (e.g., 48 V battery) through regenerative braking. Accordingly, fuel efficiency of the mild hybrid electric vehicle may be improved. The mild hybrid electric vehicle provides idle stop mode to prevent unnecessary idling and fuel consumption when the engine power is not used. However, when the frequency of entering idle stop mode is high, durability of the battery may decrease rapidly and the driver may experience discomfort. Particularly, when the vehicle enters the idle stop mode frequently while the vehicle is on an uphill road or in a parking area, the risk of an accident due to a delayed engine start may increase.

The above information disclosed in this section is merely for enhancement of understanding of the background of the invention and therefore it may contain information that does not form the prior art that is already known in this country to a person of ordinary skill in the art.

### SUMMARY

The present invention provides an apparatus and method for controlling a mild hybrid electric vehicle that may decrease the risk of an accident and increase the durability of the battery by reducing the frequency of entering an idle stop on the uphill road or in the parking area.

An apparatus for controlling a mild hybrid electric vehicle according to an exemplary embodiment of the present invention may include: an engine; a mild hybrid starter and generator (MHSG) configured to start the engine or generate power by an output of the engine; a data receiving unit configured to receive at least vehicle speed data, vehicle location data and traffic information; and a controller configured to adjust a state of charge (SOC) criteria for idle stop restriction based on the data supplied from the data receiving unit.

When the vehicle speed is less than a predetermined speed, the controller may be configured to determine whether the vehicle is in a uphill section, and when the vehicle is determined to be in the uphill section, the controller may be configured to increase a SOC criteria for idle stop restriction from a default SOC value to an increased SOC value. When the vehicle speed is equal to or greater than the predetermined speed, the controller may be configured to maintain the SOC criteria for idle stop restriction at the default SOC value.

When the vehicle is determined to be out of the uphill section, the controller may be configured to decrease the SOC criteria for idle stop restriction from the increased SOC value to the default SOC value. When the vehicle is determined to be remain in the uphill section, the controller may be configured to maintain the SOC criteria for idle stop restriction at the increased SOC value. Further, the traffic information may include navigation information, and the controller may be configured to determine the vehicle to be in the uphill section when the vehicle is at least traveling up a ramp or in a building or a parking area.

A method for controlling mild hybrid electric vehicle according to an exemplary embodiment of the present invention may include: determining whether a speed of the vehicle less than a predetermined speed; when the vehicle speed is less than the predetermined speed, determining whether the vehicle is in a dangerous section based on a vehicle location information and a traffic information; and when the vehicle is determined to be in the dangerous section, increasing a SOC criteria for idle stop restriction from a default SOC value to an increased SOC value.

The method may further include when the vehicle speed is equal to or greater than the predetermined speed, maintaining the SOC criteria for idle stop restriction at the default SOC value. When the vehicle is determined to be out of the uphill section, the method may include decreasing the SOC criteria for idle stop restriction from the increased SOC value to the default SOC value. When the vehicle is determined to still be in the uphill section, the method may include maintaining the SOC criteria for idle stop restriction at the increased SOC value. Additionally, the traffic information may include navigation information, and the vehicle may be determined to be in the dangerous section when the vehicle is at least traveling up a ramp or in a building or a parking area.

According to an exemplary embodiment of the present invention, the present invention provides an apparatus and method for controlling a mild hybrid electric vehicle that may decrease the risk of the accident and increase the durability of the battery by reducing the frequency of entering the idle stop on the uphill road or in the parking area

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a block diagram of a mild hybrid electric vehicle according to an exemplary embodiment of the present invention;

FIG. 2 is a diagram illustrating a portion of an apparatus for controlling mild hybrid electric vehicle according to an exemplary embodiment of the present invention; and

FIG. 3 is a flowchart illustrating a method for controlling mild hybrid electric vehicle according to an exemplary embodiment of the present invention.

### DESCRIPTION OF SYMBOLS

1: Vehicle
10: Engine
110: Transmission
120: MHSG
130: Battery
140: Differential Gear Apparatus
150: Wheel
160: Auxiliary Battery
170: Controller
180: Data Receiving Unit
181: Vehicle Speed Detector
183: Location Information Module
185: SOC Detector

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment. In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In the following detailed description, exemplary embodiments of the present application will be described more fully with reference to the accompanying drawings, in which exemplary embodiments of the invention are shown. However, the present invention is not limited the exemplary embodiments which are described herein, and may be modified in various different ways.

Parts which are not related with the description are omitted for clearly describing the exemplary embodiment of the present invention, and like reference numerals refer to like or similar elements throughout the specification. Since each component in the drawings is arbitrarily illustrated for easy description, the present invention is not particularly limited to the components illustrated in the drawings.

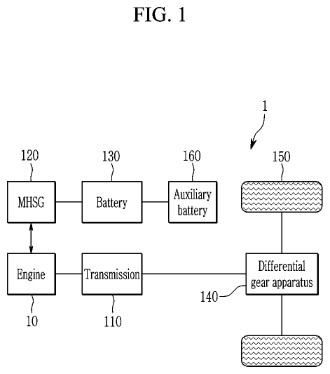

FIG. 1 is a block diagram of a mild hybrid electric vehicle according to an exemplary embodiment of the present invention. As shown in FIG. 1, a mild hybrid electric vehicle 1 according to an exemplary embodiment of the present invention may include an engine 10, a transmission 110, a mild hybrid starter & generator (MHSG) 120, a battery 130, a differential gear apparatus 140, a wheel 150 and an auxiliary battery 160.

In connection with torque transmission of the mild hybrid electric vehicle 1, torque generated from the engine 10 is transmitted to an input shaft of the transmission 110, and a torque output from an output shaft of the transmission 110 is transmitted to an axle via the differential gear apparatus 140. The axle rotates the wheel 150 to operate the mild hybrid electric vehicle using the torque generated from the engine 10. The MHSG 120 may be configured to start the engine 10 or generated electricity based on an output of the engine 10. In addition, the MHSG 120 may assist the torque of the engine 10. In other words, the torque of the engine 10 may be used as main torque, and a torque of the MHSG 120 may be used as auxiliary torque. The MHSG 120 may be an inverter-integrated MHSG.

Further, the battery 130 may be configured to supply electricity to the MHSG 120, and may be charged through electricity recovered by the MHSG 120 in a regenerative braking mode. The battery 130 may have 48 V voltage. The battery 130 may be a LDC-integrated battery including a LDC (low voltage DC-DC converter) configured to convert a voltage supplied form the battery 130 into a low voltage. The mild hybrid electric vehicle 1 may further include an auxiliary battery 160 charged with the low voltage converted by the LDC, and configured to supply low voltage (e.g., 12V) power to electronic loads of the mild hybrid electric vehicle 1.

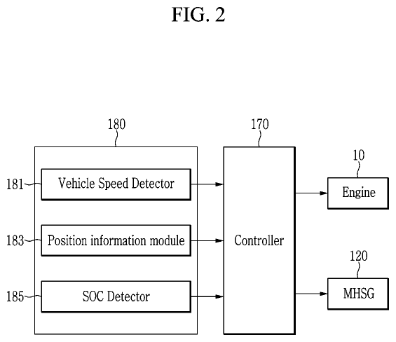

FIG. 2 is a diagram illustrating a portion of an apparatus for controlling a mild hybrid electric vehicle according to an exemplary embodiment of the present invention. As shown in FIG. 2, the apparatus configured to control the mild hybrid electric vehicle according to an exemplary embodiment of the present invention may further include a controller 170 and a data receiving unit 180.

The controller 170 may be configured to execute the idle stop operation of the vehicle 1 based on the data such as vehicle speed information and vehicle location information supplied from the data receiving unit 180. The data receiving unit 180 may be configured to receive the data required for executing the idle stop operation and supply the information to the controller 170. The data receiving unit may include a vehicle speed detector 181, location information module 183 and SOC detector 185. The various detectors and modules may be sensors mounted within the vehicle. The data receiving unit 180 may further include detectors or sensors configured to receive data required for operating the mild hybrid electric vehicle (e.g., engine speed detector, acceleration detector).

In particular, the vehicle speed detector 181 may be configured to detect the speed of the vehicle 1 and generate vehicle speed data. The controller 170 may be configured to receive the vehicle speed data required for executing the idle stop operation through the vehicle speed detector 181. The location information module 183 may be configured to receive at least location information of the vehicle 1 and traffic information. The location information of the vehicle 1 may be global positioning system (GPS) information. The traffic information may be navigation information or other location-based information supplied from a traffic information service provider, and may include information of an uphill section such as ramp or parking area. The controller 170 may be configured to receive the vehicle location information and the traffic information required for executing the idle stop operation from the location information module 183.

The SOC detector 185 may be configured to detect a state of charge (SOC) of the battery 130 and generate SOC data. The controller 170 may be configured to receive the SOC data required for executing the idle stop operation from the SOC detector 185. When the SOC of the battery 130 detected by the SOC detector 185 is less than the SOC criteria for idle stop restriction, the controller may be configured to restrict the vehicle from entering idle stop.

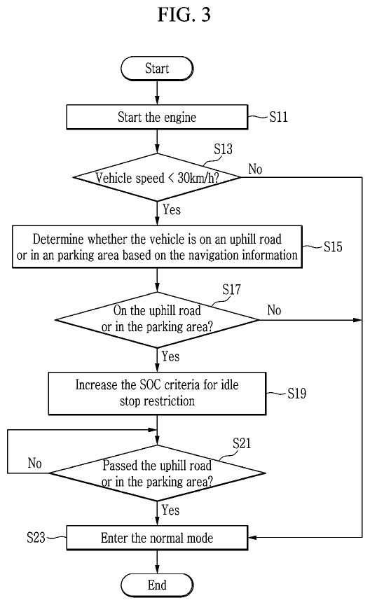

Hereinafter, a method for controlling mild hybrid electric vehicle according to an exemplary embodiment of the present invention will be described with reference to FIG. 3. FIG. 3 is a flowchart illustrating the method for controlling mild hybrid electric vehicle according to an exemplary embodiment of the present invention. The method described herein below may be executed by a controller having a processor and a memory.

As shown in FIG. 3, when the engine starts at step S11, the controller 170 may be configured to determine whether the vehicle speed is less than a predetermined speed at step S13. The predetermined speed may be set to a value determined by a person of ordinary skill in the art to be suitable for the idle stop operation control. For example, the predetermined speed may be about 30 kph. When the vehicle speed is equal to or greater than the predetermined speed at step S13, the controller 170 may enter a normal mode in which the SOC criteria for idle stop restriction is set as a default SOC value at step S23. The default SOC value may be set to a value determined by a person of ordinary skill in the art to be sufficient for the reliable engine start-up after idle stop in general situation. For example, the default SOC value may be about 50% of the maximum SOC value of the battery 130.

When the vehicle speed is less than the predetermined speed at step S13, the controller 170 may be configured to determine whether the vehicle 1 is in an uphill section based on vehicle location information and traffic information at step S15. In particular, the controller 170 may be configured to determine that the vehicle 1 is in an uphill section when the vehicle is traveling up a ramp or is located in the parking area. The uphill section may further include other places or sections in which a person of ordinary skill in the art determines that a vehicle is on the uphill road or may be frequently on the uphill road. The uphill road refers to an inclined road section on which the vehicle is traveling or is parked.

When the controller 170 determines that the vehicle 1 is not in the uphill section at step S17 (e.g., the road on which the vehicle is traveling is substantially flat and is not inclined), the controller 170 may enter the normal mode at step S23. When the controller 170 determines that the vehicle 1 is in the uphill section at step S17, the controller 170 may be configured to increase the SOC criteria for idle stop restriction from the default SOC value to the increased SOC value at step S19. The increased SOC value may be set to a value determined by a person of ordinary skill in the art to be sufficient for the reliable engine start-up after idle stop when the vehicle is in the uphill section. For example, the increased SOC value may be about 90% of the maximum SOC value of the battery 130.

The frequency with which the vehicle 1 enters idle stop may be reduced when the controller 170 increases the SOC criteria for idle stop restriction when the vehicle 1 in the uphill section. This may reduce the risk of the vehicle facing dangerous situations due to the time required to restart the engine 10. In addition, even when the vehicle 1 enters idle stop in the uphill section, the vehicle may have sufficient SOC of the battery 130 to ensure more reliable and rapid engine start-up. Accordingly, startability of the engine may be improved and the safety of the mild hybrid electric vehicle 1 may be ensured when the vehicle 1 is in the uphill section. In other words, the controller may be configured to operate the mild hybrid electric vehicle at the adjusted SOC criteria based on the determination of whether the vehicle remains in an uphill region.

Further, durability of the battery 130 may be improved due to the decreased frequency of unnecessary idle stop entry. The controller 170 may be configured to determine whether the vehicle 1 passed and exited the uphill section at step S21 (e.g., is no longer traveling or located in an inclined road region). When the controller 170 determines that vehicle 1 remains in the uphill section at step S21, the controller 170 may be configured to maintain the SOC criteria for idle stop restriction at the increased SOC value. When the controller determines that vehicle 1 passed the uphill section at step S21, the controller 170 may enter normal mode at step S23. In other words, the controller 170 may be configured to set the SOC criteria for idle stop restriction to be the default SOC value.

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. An apparatus for controlling mild hybrid electric vehicle, comprising:
an engine;
a mild hybrid starter and generator (MHSG) configured to start the engine or generate power by an output of the engine;
a data receiving unit configured to receive at least vehicle speed data, vehicle location data, and traffic information; and
a controller configured to adjust a state of charge (SOC) criteria for idle stop restriction based on the data supplied from the data receiving unit,
wherein when the speed of the vehicle is less than a predetermined speed, the controller is configured to determine whether the vehicle is in a uphill section, and
wherein when the vehicle is determined to be in the uphill section, the controller is configured to increase the SOC criteria for idle stop restriction from a default SOC value to an increased SOC value.

2. The apparatus of claim 1, wherein when the speed of the vehicle is equal to or greater than the predetermined speed, the controller is configured to maintain the SOC criteria for idle stop restriction at the default SOC value.

3. The apparatus of claim 1, wherein when the vehicle is determined to be beyond the uphill section, the controller is configured to decrease the SOC criteria for idle stop restriction from the increased SOC value to the default SOC value.

4. The apparatus of claim 1, wherein when the vehicle is determined to remain in the uphill section, the controller is configured to maintain the SOC criteria for idle stop restriction at the increased SOC value.

5. The apparatus of claim 1, wherein the traffic information includes navigation information, and the controller is configured to determine that the vehicle is in the uphill section when the vehicle is at least traveling up a ramp or a parking area.

6. A method for controlling mild hybrid electric vehicle, comprising:
determining, by a controller, whether a speed of the vehicle less than a predetermined speed;
determining, by the controller, whether the vehicle is in a dangerous section based on a vehicle location information and a traffic information when the vehicle speed is less than the predetermined speed; and
increasing, by the controller, a state of charge (SOC) criteria for idle stop restriction from a default SOC value to an increased SOC value when the vehicle is determined to be in the dangerous section.

7. The method of claim 6, further comprising:
maintaining, by the controller, the SOC criteria for idle stop restriction at the default SOC value when the vehicle speed is equal to or greater than the predetermined speed.

8. The method of claim 6, further comprising:
decreasing, by the controller, the SOC criteria for idle stop restriction from the increased SOC value to the default SOC value when the vehicle is determined to be beyond the uphill section.

9. The method of claim 6, further comprising:
maintaining, by the controller, the SOC criteria for idle stop restriction at the increased SOC value when the vehicle is determined to remain in the uphill section.

10. The method of claim 6, wherein the traffic information includes navigation information, and the vehicle is determined to be in the dangerous section when the vehicle is at least traveling up a ramp or a parking area.
